(19) United States
(12) Patent Application Publication
(10) Pub. No.: US 2015/0085218 A1
(43) Pub. Date: Mar. 26, 2015

(54) LIQUID CRYSTAL DISPLAY PANEL

(71) Applicant: Japan Display Inc., Tokyo (JP)

(72) Inventors: Yasushi TOMIOKA, Tokyo (JP); Takato HIRATSUKA, Tokyo (JP); Osamu ITOU, Tokyo (JP)

(21) Appl. No.: 14/490,723

(22) Filed: Sep. 19, 2014

(30) Foreign Application Priority Data
Sep. 20, 2013 (JP) 2013-195660

(51) Int. Cl. G02F 1/1343; G02F 1/1337; G02F 1/1368; G02F 1/1335

(52) U.S. Cl. CPC G02F 1/134363; G02F 1/133512; G02F 1/133788; G02F 1/13439; G02F 1/1368; G02F 2001/133738
USPC 349/42; 349/33; 349/123

(57) ABSTRACT

The present invention provides a high-definition, high-contrast, and high-aperture-ratio liquid crystal display device that prevents light leakage near wall electrodes. There is provided a liquid crystal display device including: two parallel wall electrodes that are disposed on the both sides of a pixel; an opposite electrode that is disposed in the middle between the two parallel wall electrodes; and a photo-alignment film, wherein the initial alignment direction of liquid crystal of the photo-alignment film is substantially parallel to or orthogonal to the stretching direction of the two parallel wall electrodes, and the opposite electrode is inclined only by a predetermined bias angle relative to the initial alignment direction of liquid crystal.

### CLAIM OF PRIORITY

The present application claims priority from Japanese Patent Application JP 2013-195660 filed on Sep. 20, 2013, the content of which is hereby incorporated by reference into this application.

### BACKGROUND

The present invention relates to an In-Plane Switching liquid crystal display device using wall electrodes, and also relates to a high-definition, high-contrast, and high-aperture-ratio liquid crystal display device.

An IPS (In-Plane Switching) liquid crystal display device has been developed to realize a wide viewing angle. In the IPS liquid crystal display device, while liquid crystal molecules are horizontally aligned, an electric field parallel to a substrate is applied to rotate the liquid crystal molecules in a horizontal plane, so that the light amount of backlight is controlled to display an image.

As an example of the IPS liquid crystal display device, Japanese Unexamined Patent Application Publication No. Hei 6-214244 (see Abstract) discloses a liquid crystal display device that includes m-by-n matrix pixels, active elements in pixels, a driving unit that applies a predetermined voltage waveform, pairs of electrodes in the pixels to keep a gap between upper and lower substrates constant, and a predetermined structure that controls the alignment state of liquid crystal molecules to modulate light by applying an electric field parallel to the surface of a substrate between the pair of electrodes.

“Sitao Huo, Baoling Liu, Wenxin Jiang, Proceedings of China Display/Asia Display 2011, p. 2-23, p. 597-600” discloses an IPS liquid crystal display device that controls the alignment state of liquid crystal by forming transparent electrodes on inclined surfaces of walls to induce an electric field substantially parallel to the plane of a substrate.

Further, a photo-alignment method has been proposed as a processing method of providing a liquid crystal alignment film with an alignment function in a liquid crystal display element. In the photo-alignment method, linearly-polarized ultraviolet light (polarized UV light) or the like is irradiated onto a polymer film containing a photoisomerization compound such as azo dye to selectively react a photoisomerization compound and a polymer chain in a polarization direction, so that the alignment function of liquid crystal is provided by generating anisotropy in the arrangement of molecules of the polymer film.

In FIG. 7 of Japanese Unexamined Patent Application Publication No. 2012-113212, an IPS liquid crystal display device in which a photo-alignment film is formed is disclosed as an IPS liquid crystal display device using a photo-alignment film.

### SUMMARY

The invention described in each of Japanese Unexamined Patent Application Publication No. Hei 6-214244 and “Sitao Huo, Baoling Liu, Wenxin Jiang, Proceedings of China Display/Asia Display 2011, p. 2-23, p. 597-600” is provided with a wall electrode structure. However, an alignment method and use of a photo-alignment film are not described. Further, the invention described in Japanese Unexamined Patent Application Publication No. 2012-113212 uses comb-like electrodes, but is not provided with a wall electrode structure.

A liquid crystal display device including a wall electrode structure with a photo-alignment film studied prior to the present invention will be described. FIGS. 3A and 3B show one pixel of a liquid crystal display device, FIG. 3A shows a plan view of one pixel, and FIG. 3B shows a cross-sectional view taken along the line A-B of FIG. 3A.

As shown in FIG. 3B, the cross-sectional structure on the A-B plane includes large wall structures (hereinafter, referred to as large walls 13) disposed on the both sides of the pixel, and side faces of the large walls 13 are covered with wall electrodes 17. In the example, the wall electrodes 17 extend from the surface in contact with the substrate in the center direction to form plane electrodes. The wall electrodes and the plane electrodes are electrically connected to each other to serve as pixel electrodes. A wall structure (hereinafter, referred to as a small wall 14) whose height is shorter than that of the large wall structure is provided between the large wall structures at the boundary of the pixels. An opposite electrode 15 is formed so as to cover the small wall 14. In the example, the opposite electrode 15 extends on the entire surfaces of the pixels including upper portions of the large walls 13 to form a common electrode. An interlayer insulating film 16 is provided between the common electrode and the plane electrode, and an area where the common electrode is overlapped with the plane electrode forms a retentive capacity. A photo-alignment film 19 is formed on the wall electrodes 17 through an insulating film 18. It should be noted that drain wirings 11 are provided on a substrate (not shown) and the large walls 13 and the small walls 14 are provided on an insulating film 12 formed to cover the drain wirings 11.

In the liquid crystal display device having such wall electrodes, as shown in FIG. 3A, the photo-alignment film 19 is aligned while being inclined only by a bias angle ø (ø is about 1 to 15 degrees) relative to the longitudinal direction of the wall electrodes 17. Accordingly, the initial alignment direction of liquid crystal is inclined only by the bias angle ø relative to the stretching direction of the wall electrodes, and excellent driving of liquid crystal molecules is realized by in-plane rotation.

However, if the photo-alignment method in which linearly-polarized light is irradiated is applied to wall electrodes whose inclination angles are steep, the alignment direction of liquid crystal near the wall electrodes becomes different from a desired direction. In addition, when viewing with the polarizing plate crossed-Nicols, light leakage occurs near the wall electrodes, resulting in a decrease in the contrast ratio.

As a probable cause of the disordered alignment in this case, if the inclination of the wall structure becomes steeper, the effective amount of light irradiation at the inclined parts of the wall side faces is decreased as compared to that in a flat pixel area. Thus, it is conceivable that sufficient anchoring (alignment restraining force) of liquid crystal molecules cannot be obtained.

Further, it is conceivable that, when each inclined surface of the walls is shifted from the polarizing axis of polarized UV light by about 0 to 90 degrees, the alignment axis of the inclined surface is shifted from a desired axis, and light leakage occurs near the walls.

Further, it is conceivable that, when UV reflected light whose polarizing axis is shifted from each inclined surface of the walls is irradiated again onto a pixel area near the walls, the alignment functions of liquid crystal of two axes are provided to an area on the surface of the alignment film, the direction of the alignment axis in the pixel area near the walls is disordered, and light leakage occurs.

In order to prevent the light leakage, a light leakage area near the walls is covered with a light-shielding black matrix BM, so that a high contrast ratio can be ensured. However, a light-shielding area becomes wide, and thus the aperture ratio and the transmittance are decreased. Thus, it is difficult to satisfy the both of high transmittance and a high contrast ratio.

An object of the present invention is to provide a high-definition, high-contrast, and high-aperture-ratio liquid crystal display device that prevents light leakage near wall electrodes.

In order to solve the above-described problems, the present invention employs, for example, configurations described in Claims.

According to a representative example of the present invention, there is provided a liquid crystal display device including: two parallel wall electrodes that are disposed on the both sides of a pixel; an opposite electrode that is disposed in the middle between the two parallel wall electrodes; and a photo-alignment film, in which the initial alignment direction of liquid crystal of the photo-alignment film is substantially parallel to or orthogonal to the stretching direction of the two parallel wall electrodes, and the opposite electrode is inclined only by a predetermined bias angle relative to the initial alignment direction of liquid crystal.

Further, according to another example of the present invention, there is provided a liquid crystal display device including: two parallel wall electrodes that are disposed on the both sides of a pixel; an opposite electrode that is disposed in the middle between the two parallel wall electrodes; and a photo-alignment film, in which the initial alignment direction of liquid crystal of the photo-alignment film is substantially parallel to the stretching direction of the two parallel wall electrodes, a substantially symmetrical bent structure having a predetermined bias angle ø (ø is 1 to 20 degrees) relative to the initial alignment direction of liquid crystal is formed at one terminal portion of the opposite electrode, the bent structure having the bias angle is not formed at the other terminal portion of the opposite electrode, ends of pixel electrodes extending in a flat area of the pixel from the wall electrodes are inclined only by a predetermined angle α (0<α≦90 degrees) in the rotational direction same as the bias angle relative to the initial alignment direction of liquid crystal, and a substantially symmetrical notch end of the pixel electrode is formed.

According to the present invention, it is possible to provide a high-definition, high-contrast, and high-aperture-ratio liquid crystal display device that prevents light leakage near wall electrodes.

### BRIEF DESCRIPTION OF THE DRAWINGS

FIG. 1A is a diagram for showing a structure of a liquid crystal display device according to a first embodiment of the present invention;

FIG. 1B is a diagram for showing a structure of the liquid crystal display device according to the first embodiment of the present invention;

FIG. 2 is a diagram for showing a cross-sectional surface near a large wall according to the first embodiment of the present invention;

FIG. 3A is a diagram for showing a structure of a liquid crystal display device studied prior to the present invention;

FIG. 3B is a diagram for showing a structure of the liquid crystal display device studied prior to the present invention;

FIG. 4A is a diagram for showing a structure of a liquid crystal display device according to a second embodiment of the present invention;

FIG. 4B is a diagram for showing a structure of the liquid crystal display device according to the second embodiment of the present invention;

FIG. 4C is a diagram for showing a structure of the liquid crystal display device according to the second embodiment of the present invention;

FIG. 4D is a diagram for showing a structure of the liquid crystal display device according to the second embodiment of the present invention;

FIG. 4E is a diagram for showing a structure of the liquid crystal display device according to the second embodiment of the present invention;

FIG. 5A is a diagram for showing a structure of a liquid crystal display device according to a third embodiment of the present invention;

FIG. 5B is a diagram for showing a structure of the liquid crystal display device according to the third embodiment of the present invention;

FIG. 5C is a diagram for showing a structure of the liquid crystal display device according to the third embodiment of the present invention;

FIG. 6A is a diagram for showing a structure of a liquid crystal display device according to a fourth embodiment of the present invention;

FIG. 6B is a diagram for showing a structure of the liquid crystal display device according to the fourth embodiment of the present invention;

FIG. 6C is a diagram for showing a structure of the liquid crystal display device according to the fourth embodiment of the present invention;

FIG. 7A is a diagram for showing a structure of a liquid crystal display device according to a fifth embodiment of the present invention;

FIG. 7B is a diagram for showing a structure of the liquid crystal display device according to the fifth embodiment of the present invention;

FIG. 7C is a diagram for showing a structure of the liquid crystal display device according to the fifth embodiment of the present invention;

FIG. 8A is a diagram for showing a structure of a liquid crystal display device according to a sixth embodiment of the present invention;

FIG. 8B is a diagram for showing a structure of the liquid crystal display device according to the sixth embodiment of the present invention;

FIG. 8C is a diagram for showing a structure of the liquid crystal display device according to the sixth embodiment of the present invention;

FIG. 9A is a diagram for showing a structure of a liquid crystal display device according to a seventh embodiment of the present invention;

FIG. 9B is a diagram for showing a structure of the liquid crystal display device according to the seventh embodiment of the present invention;

FIG. 9C is a diagram for showing a structure of the liquid crystal display device according to the seventh embodiment of the present invention;

FIG. 9D is a diagram for showing a structure of the liquid crystal display device according to the seventh embodiment of the present invention;

FIG. 10A is a diagram for showing a structure of a liquid crystal display device according to an eighth embodiment of the present invention;

FIG. 10B is a diagram for showing a structure of the liquid crystal display device according to the eighth embodiment of the present invention;

FIG. 10C is a diagram for showing a structure of the liquid crystal display device according to the eighth embodiment of the present invention;

FIG. 11A is a diagram for showing a structure of a liquid crystal display device according to a ninth embodiment of the present invention;

FIG. 11B is a diagram for showing a structure of the liquid crystal display device according to the ninth embodiment of the present invention;

FIG. 11C is a diagram for showing a structure of the liquid crystal display device according to the ninth embodiment of the present invention; and

FIG. 12 is a diagram for showing a structure of the liquid crystal display device according to the ninth embodiment of the present invention.

### DETAILED DESCRIPTION

Hereinafter, embodiments of the present invention will be described on the basis of the drawings. It should be noted that constitutional elements having the same functions are given the same names and reference numerals in the all drawings for explaining the embodiments, and explanations thereof will not be repeated.

### First Embodiment

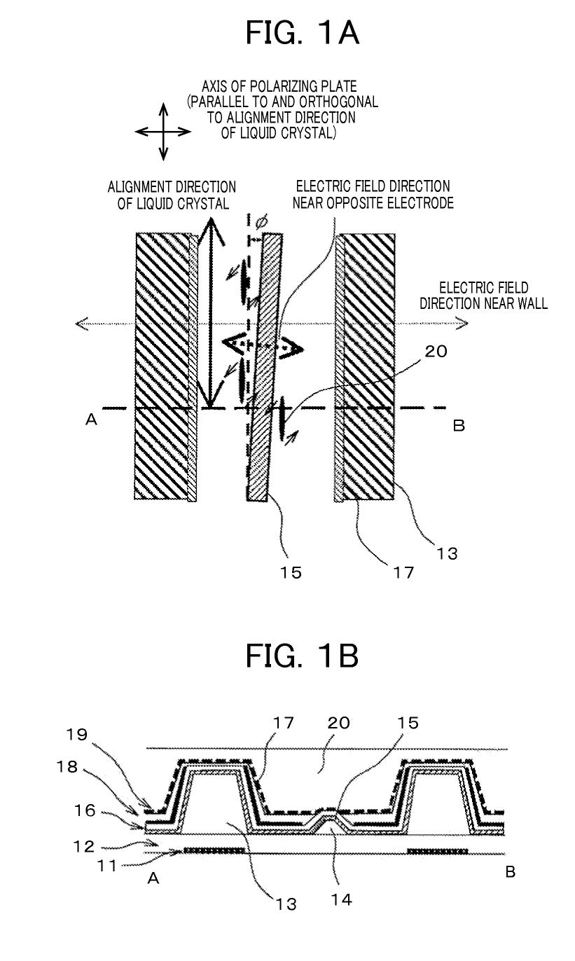

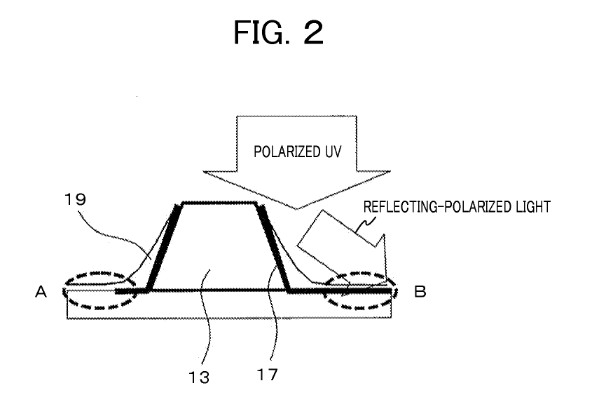

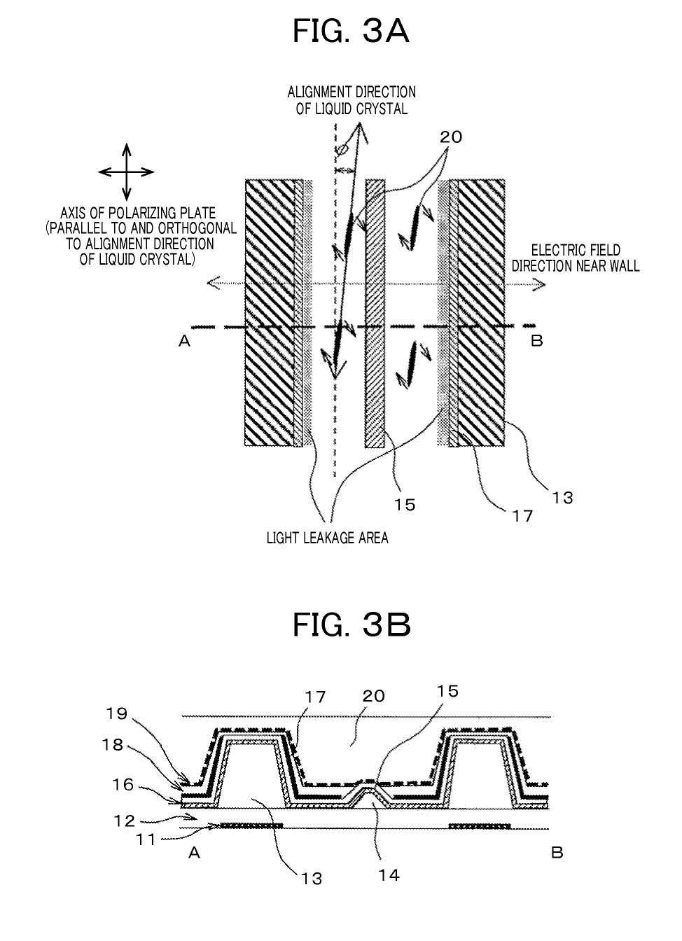

FIG. 1 are diagrams each explaining a structure of a liquid crystal display device according to a first embodiment of the present invention. FIG. 1A shows a plan view of one pixel, and FIG. 1B shows a cross-sectional view taken along the line A-B of FIG. 1A. It should be noted that the vertical direction (thickness direction of the pixel) is more emphatically illustrated than the horizontal direction (width direction of the pixel) in FIG. 1B. Further, FIG. 2 is a diagram for explaining operational effects of the embodiments and for showing a cross-sectional surface near a large wall.

In FIG. 1B, drain wirings 11 are provided on a substrate (not shown), and an insulating film 12 is formed so as to cover the drain wirings 11. Large walls 13 are disposed on the both sides of each pixel on the insulating film 12, and a small wall 14 that is shorter in height than the large walls 13 is provided in the middle of each pixel. An opposite electrode 15 is formed so as to cover the small wall 14. The opposite electrode 15 extends on the entire surface of each pixel including the upper portions of the large walls 13 to form a common electrode. An interlayer insulating film 16 is formed on the common electrode, and wall electrodes 17 cover the side faces of the large walls 13 on the interlayer insulating film. Each wall electrode 17 extends from the surface close to the substrate in the direction of the small wall 14 to form a pixel electrode. An area where the common electrode is overlapped with the pixel electrode forms a retentive capacity. An insulating film 18 is formed on the wall electrodes (pixel electrodes), and a photo-alignment film 19 is provided thereon.

It should be noted that the embodiment is provided with a source-top structure in which the opposite electrode 15 and electrodes extending from the opposite electrode 15 in the plane direction parallel to the substrate are used as common electrodes, the wall electrodes 17 and electrodes extending from the wall electrodes 17 in the plane direction parallel to the substrate are used as pixel electrodes (source electrodes), and a boundary between the wall electrodes 17 of the adjacent two pixels is disposed on, at least, the top of the wall structure.

In the embodiment, the wall electrodes 17 on the both sides of each pixel are used as pixel electrodes, and the opposite electrodes 15 are used as common electrodes. However, the wall electrodes 17 on the both sides of each pixel may be used as common electrodes, and the opposite electrodes 15 may be used as pixel electrodes by dividing the same in each pixel.

As shown in the plan view of FIG. 1A, the photo-alignment film 19 is aligned substantially parallel to the longitudinal direction of the wall electrodes 17. Accordingly, in the case of using positive liquid crystal, the initial alignment direction of liquid crystal becomes substantially parallel to the stretching direction of the wall electrodes. The opposite electrode 15 located in the middle of the two parallel wall electrodes 17 is configured to be inclined only by an initial bias angle ø (ø is 1 to 20 degrees) relative to the initial alignment direction of liquid crystal.

Using this configuration, the electric field directions near the walls are orthogonal to the initial alignment direction of liquid crystal as shown in the drawing. However, the electric field direction near the opposite electrode in the middle is in the direction of a fringe electric field that is inclined only by the initial bias angle ø. In addition, changes of alignment of liquid crystal caused by applying voltage are excited from near the opposite electrode 15 by the fringe electric field. Thus, the rotational direction of liquid crystal 20 is stabilized, and reverse twisted domains can be prevented from being generated.

Further, the alignment direction of the photo-alignment film 19 is set to be substantially parallel to the stretching direction of the wall electrodes 17, namely, the large walls 13. Thus, as shown in FIG. 2, polarized UV light becomes nearly-complete p-polarized light or s-polarized light relative to the inclined surfaces of the wall 13. Accordingly, the polarizing axis of reflected light does not change, each pixel area keeps an excellent alignment direction, and light leakage near the wall electrodes can be prevented.

In addition, since light leakage near the wall electrodes can be prevented, high contrast can be realized, and the width of a light-shielding black matrix BM can be shortened or eliminated. Thus, a high aperture ratio and a high transmittance can be realized. Further, the width of the light-shielding black matrix BM is allowed to be shortened or eliminated, so that an alignment margin for upper and lower substrates can be enlarged, and productivity can be improved. In particular, the present invention is effective for a high-definition product over 300 ppi.

It should be noted that in the case of using negative liquid crystal, the initial alignment direction of liquid crystal is substantially orthogonal to the stretching direction of the wall electrodes. However, the same effect as the positive liquid crystal can be obtained.

### Second Embodiment

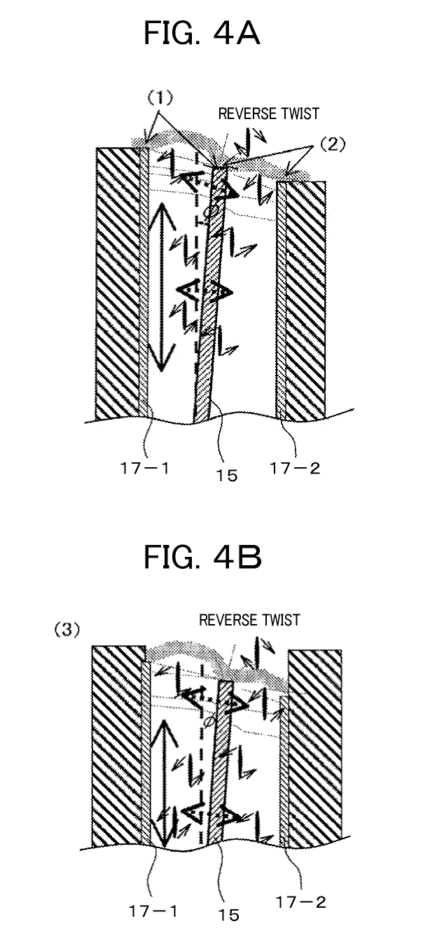

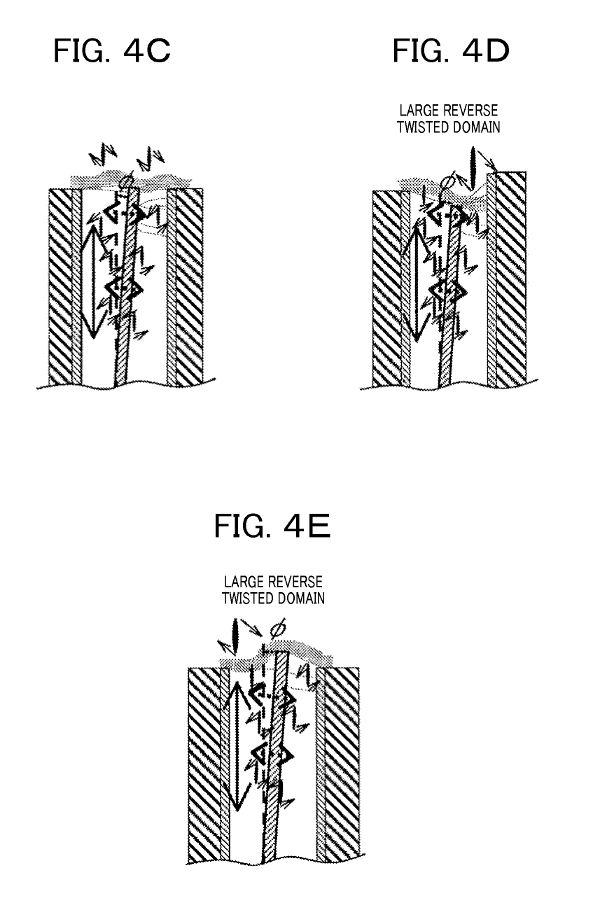

FIG. 4A is a diagram for explaining a structure of a liquid crystal display device according to a second embodiment of the present invention, and FIG. 4B is a diagram for showing a modified example of the second embodiment. Further, FIGS. 4C to 4E are diagrams for showing comparison examples.

In FIG. 4A, the position of a tip section of a wall electrode 17-1 located far from the opposite electrode 15 that is inclined only by the bias angle ø relative to the initial alignment direction of liquid crystal parallel to the wall electrodes is relatively the same as that of the opposite electrode 15 or extends outside the pixel farther than the tip section of the opposite electrode 15 as shown in (1). With this configuration, a boundary between the reverse twisted domains shown using gray areas in the drawing can be disposed on the outer side of the pixel, and the transmittance can be improved. It should be noted that the fine dotted line in the drawing denotes a line of electric force.

Further, the position of a tip section of a wall electrode 17-2 located near the opposite electrode 15 that is inclined only by the bias angle ø relative to the initial alignment direction parallel to the wall electrodes is relatively the same as that of the opposite electrode 15 or does not extend outside the pixel farther than the tip section of the opposite electrode 15 as shown in (2). With this configuration, a boundary between the reverse twisted domains shown using gray areas in the drawing can be disposed on the outer side of the pixel, and the transmittance can be improved.

FIG. 4B shows a modified example of FIG. 4A in which the large walls are located on the same positions on the both sides and the wall electrodes 17-1 and 17-2 are terminated in the middle of the wall structures. The position of the tip section of the wall electrode 17-1 located far from the opposite electrode 15 relative to the tip section of the opposite electrode 15 and the position of the tip section of the wall electrode 17-2 located near the opposite electrode 15 relative to the tip section of the opposite electrode 15 are the same as the relations of FIG. 4A. With this configuration, a boundary between the reverse twisted domains shown using gray areas in the drawing can be disposed on the outer side of the pixel, and the transmittance can be improved.

FIGS. 4C to 4E show comparison examples. FIG. 4C shows an example in which the position of the tip section of the opposite electrode 15, the position of the tip section of the wall electrode 17-1 located far from the opposite electrode 15, and the position of the tip section of the wall electrode 17-2 located near the opposite electrode 15 are the same. In the example, a boundary between the reverse twisted domains cannot be disposed on the outer side of the pixel.

FIG. 4D shows an example in which the position of the tip section of the wall electrode 17-2 located near the opposite electrode 15 that is inclined only by the bias angle ø relative to the initial alignment direction parallel to the wall electrodes is disposed while being relatively extended outside the pixel farther than the tip section of the opposite electrode 15. In this case, the reverse twisted domains become large, a boundary between the reverse twisted domains enters inside the pixel, and the transmittance is reduced.

FIG. 4E shows an example in which the position of the tip section of the opposite electrode 15 that is inclined only by the bias angle ø relative to the initial alignment direction parallel to the wall electrodes is disposed while being extended outside the pixel relative to the positions of the tip sections of the wall electrodes 17-1 and 17-2. In this case, too, the reverse twisted domains become large, a boundary between the reverse twisted domains cannot be disposed outside the pixel, and the transmittance is reduced.

### Third Embodiment

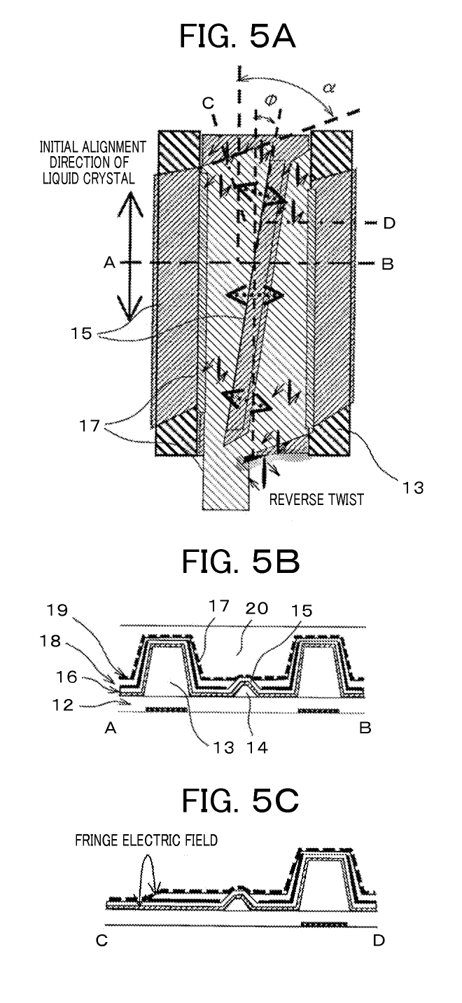

FIGS. 5A to 5C are diagrams each explaining a structure of a liquid crystal display device according to a third embodiment of the present invention. FIG. 5A shows a plan view of one pixel, FIG. 5B shows a cross-sectional view taken along the line A-B, and FIG. 5C shows a cross-sectional view taken along the line C-D. The embodiment is obtained by improving the structures of the ends of the pixel electrodes.

As shown in FIG. 5A, the initial alignment direction of liquid crystal is substantially parallel to the stretching direction of the wall electrodes 17, and the stretching direction of the opposite electrode located in the middle of the two parallel wall electrodes is rotated in the clockwise direction only by the bias angle (0<ø<20 degrees) relative to the initial alignment direction of liquid crystal. In addition, the ends of transparent pixel electrodes extending in a flat area of the pixel from the wall electrodes are inclined in the clockwise direction only by an angle α (0<α≦90 degrees) relative to the initial alignment direction of liquid crystal at the upper and lower ends of the pixel area. It should be noted that in the case where the bias angle ø of the pixel electrodes is inclined in the counterclockwise direction, the ends of the pixel electrodes are similarly inclined in the counterclockwise direction only by the angle α.

Specifically, as shown in the cross-sectional view in the C-D direction of FIG. 5C, a fringe electric field is formed between the transparent common electrode extending from the opposite electrode 15 and a notch end of the transparent pixel electrode extending from the wall electrode 17 that is formed above the common electrode through the interlayer insulating film 16 near each of the ends of the pixel electrodes in the flat area of the pixel. In addition, the thickness of the insulating film on the pixel electrode is made thinner, so that the fringe electric field is intensified, the rotation of liquid crystal is controlled, and accordingly reverse rotation domains of liquid crystal are prevented from being generated.

According to the embodiment, no light leakage occurs near the walls, and a high contrast ratio can be realized. Further, the reverse twisted domains in the vertical direction of the pixel are hardly generated, and high transmittance can be realized.

### Fourth Embodiment

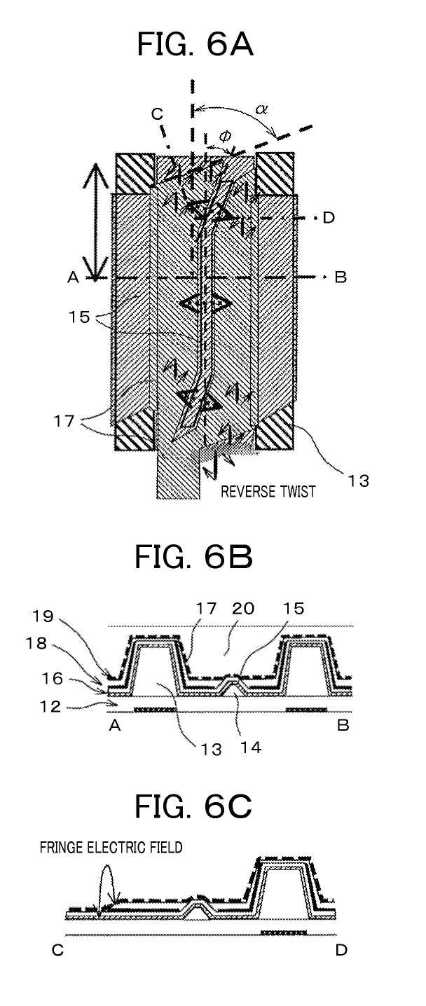

FIGS. 6A to 6C are diagrams each explaining a structure of a liquid crystal display device according to a fourth embodiment of the present invention. FIG. 6A shows a plan view of one pixel, FIG. 6B shows a cross-sectional view taken along the line A-B, and FIG. 6C shows a cross-sectional view taken along the line C-D. The embodiment is obtained by improving the structure of the opposite electrode in the liquid crystal display device of the third embodiment.

As shown in FIG. 6A, the initial alignment direction of liquid crystal is substantially parallel to the stretching direction of the wall electrodes 17, and a middle portion of the opposite electrode located in the middle of the two parallel wall electrodes is stretched in the direction substantially parallel to the stretching direction of the wall electrodes. In the case of using positive liquid crystal, at least one terminal portion of the opposite electrode is inclined in the clockwise direction only by the bias angle ø (0<ø<15 degrees) relative to the initial alignment direction of liquid crystal.

In addition, the ends of transparent pixel electrodes extending in a flat area of the pixel from the wall electrodes are inclined in the clockwise direction only by the angle α (0<α≦90 degrees) relative to the initial alignment direction of liquid crystal at the upper and lower ends of the pixel area.

Specifically, as shown in the cross-sectional view in the C-D direction of FIG. 6C, a fringe electric field is formed between the transparent common electrode extending from the opposite electrode 15 and a notch end of the transparent pixel electrode extending from the wall electrode 17 that is formed above the common electrode through the interlayer insulating film 16 near each of the ends of the pixel electrodes in the flat area of the pixel. In addition, the thickness of the insulating film on the pixel electrode is made thinner, so that the fringe electric field is intensified, the rotation of liquid crystal is controlled, and accordingly reverse rotation domains of liquid crystal are prevented from being generated.

It should be noted that in the case of an elongated pixel such as, in particular, an RGB3 pixel or an RGBW4 pixel, the length of the middle portion parallel to the wall electrodes is preferably made longer than that of the terminal portion inclined only by the bias angle relative to the wall electrodes.

According to the embodiment, no light leakage occurs near the walls, and a high contrast ratio can be realized. Further, the reverse twisted domains in the vertical direction of the pixel are hardly generated, and high transmittance can be realized.

### Fifth Embodiment

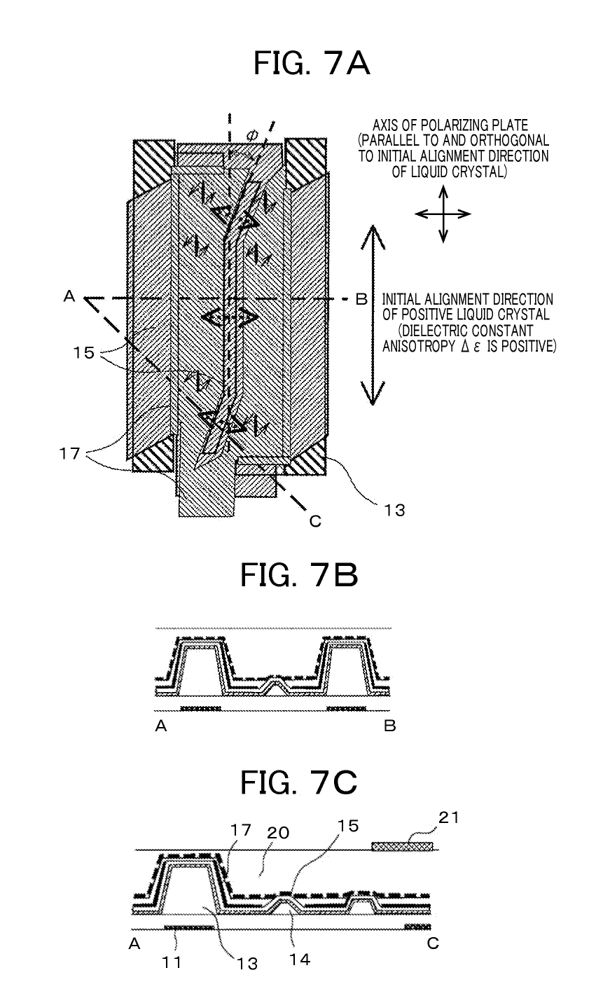

FIGS. 7A to 7C are diagrams each explaining a structure of a liquid crystal display device according to a fifth embodiment of the present invention. FIG. 7A shows a plan view of one pixel, FIG. 7B shows a cross-sectional view taken along the line A-B, and FIG. 7C shows a cross-sectional view taken along the line A-C. The embodiment is obtained by improving the structures of the tip sections of the wall electrodes in the liquid crystal display device of the fourth embodiment.

As shown in FIG. 7A, the initial alignment direction of positive liquid crystal is substantially parallel to the stretching direction of the wall electrodes 17, and the opposite electrode 15 located in the middle of the two parallel wall electrodes 17 is stretched in a middle area in the direction substantially parallel to the stretching direction of the wall electrodes 17. In addition, at least one tip section of the opposite electrode 15 is inclined in the clockwise direction only by the bias angle ø (0 to 20 degrees) relative to the initial alignment direction of liquid crystal.

In addition, the position of the tip section of the wall electrode 17 located far from the tip section of the opposite electrode 15 that is inclined only by the bias angle ø forms an L-shaped structure that is bent substantially at a right angle (89 to 91 degrees) relative to the stretching direction of the walls, and is relatively the same as that of the opposite electrode in the stretching direction of the walls or extends outside the pixel farther than the opposite electrode. Specifically, the height of the L-shaped wall electrode is equal to or higher than that of the opposite electrode and equal to or shorter than those of the wall electrodes on the both sides.

Further, in addition to the configuration, the position of the tip section of the wall electrode located near the tip section of the opposite electrode that is inclined only by the bias angle ø is relatively the same as that of the opposite electrode or does not extend outside the pixel farther than the opposite electrode.

According to the embodiment, a boundary between the reverse twisted domains can be pushed to the outside of the display area, and the transmittance can be improved.

Further, only the light-shielding black matrix BM parallel to the gate wirings (scanning wirings) is formed without providing the light-shielding black matrix BM corresponding to the wall portions parallel to the drain wirings 11 (signal wirings) in the embodiment, so that an alignment margin for upper and lower substrates (TFT substrate and CF substrate) can be enlarged.

### Sixth Embodiment

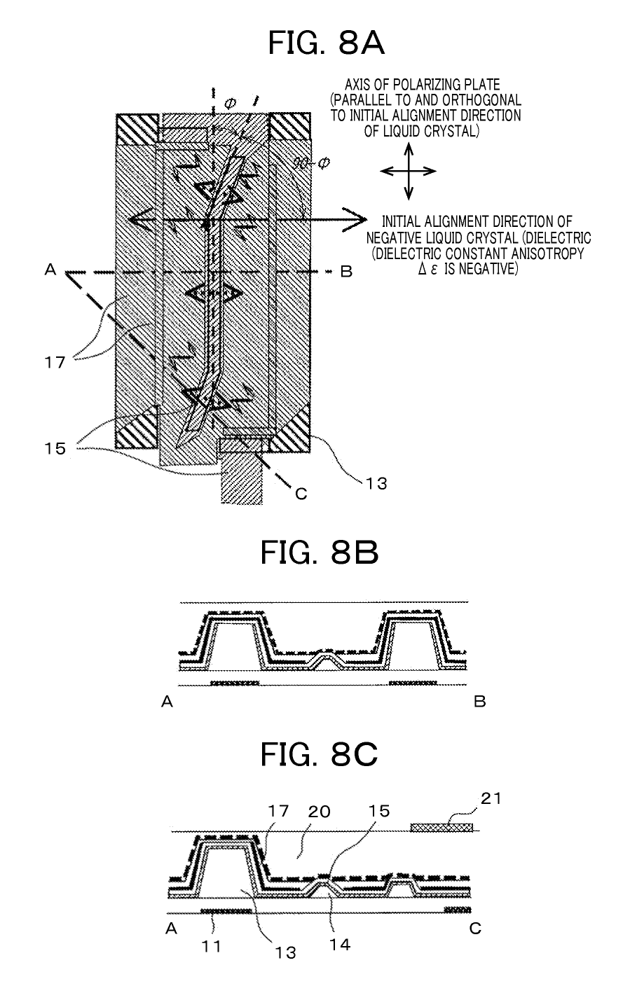

FIGS. 8A to 8C are diagrams each explaining a structure of a liquid crystal display device according to a sixth embodiment of the present invention. FIG. 8A shows a plan view of one pixel, FIG. 8B shows a cross-sectional view taken along the line A-B, and FIG. 8C shows a cross-sectional view taken along the line A-C. The embodiment is obtained by employing a common-top structure using negative liquid crystal in the liquid crystal display device of the fifth embodiment.

As shown in FIG. 8A, the initial alignment direction of negative liquid crystal is substantially orthogonal to the stretching direction of the wall electrodes 17, and the opposite electrode 15 located in the middle of the two parallel wall electrodes 17 is stretched in a middle area in the direction substantially parallel to the stretching direction of the wall electrodes 17. In addition, at least one tip section of the opposite electrode 15 is inclined in the counterclockwise direction only by the bias angle 90−ø relative to the initial alignment direction of liquid crystal.

In addition, the position of the tip section of the wall electrode 17 located far from the tip section of the opposite electrode 15 that is inclined only by the bias angle 90−ø forms an L-shaped structure that is bent substantially at a right angle relative to the stretching direction of the walls, and is relatively the same as that of the opposite electrode in the stretching direction of the walls or extends outside the pixel farther than the opposite electrode. Specifically, the height of the L-shaped wall electrode is equal to or higher than that of the opposite electrode and equal to or shorter than those of the wall electrodes on the both sides.

Further, in addition to the configuration, the position of the tip section of the wall electrode located near the tip section of the opposite electrode that is inclined only by the bias angle ø is relatively the same as that of the opposite electrode or does not extend outside the pixel farther than the opposite electrode.

Further, the embodiment is provided with a common-top structure in which the opposite electrode 15 and electrodes extending from the opposite electrode 15 in the plane direction parallel to the substrate are used as pixel electrodes (source electrodes), the wall electrodes 17 and electrodes extending from the wall electrodes 17 in the plane direction parallel to the substrate are used as common electrodes, and the wall electrodes of the adjacent two pixels are coupled to each other on, at least, the top of the wall structure.

According to the embodiment, a boundary between the reverse twisted domains can be pushed to the outside of the display area, and the transmittance can be improved. Further, similarly to the fifth embodiment, only the light-shielding black matrix BM21 parallel to the gate wirings (scanning wirings) is formed without providing the light-shielding black matrix BM corresponding to the wall portions parallel to the drain wirings 11 (signal wirings) in the embodiment, so that an alignment margin for upper and lower substrates can be enlarged.

### Seventh Embodiment

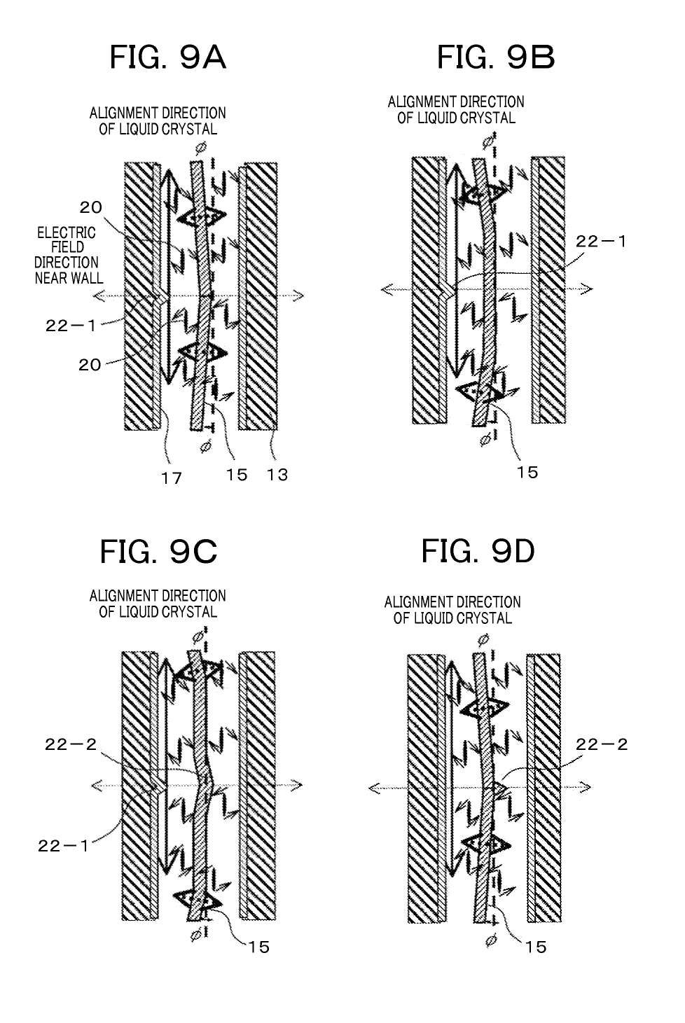

FIGS. 9A to 9D are diagrams each explaining a structure of a liquid crystal display device according to a seventh embodiment of the present invention. The embodiment is applied to a liquid crystal display device that compensates a viewing angle by dividing one pixel into an upper area and a lower area.

In each drawing, the initial alignment direction of liquid crystal is substantially parallel to the stretching direction of the wall electrodes 17. In addition, the opposite electrode 15 located in the middle between the two parallel wall electrodes 17 or the tip sections of the opposite electrode 15 are inclined only by the initial bias angle ø relative to the initial alignment direction of liquid crystal in the directions opposed to each other in the two divided upper and lower pixel areas.

In the configuration, two domains whose rotational directions of liquid crystal are opposed to each other are formed at a boundary area between the two divided upper and lower areas. In the embodiment, a protrusion structure is provided at the wall electrode 17 or the opposite electrode 15 disposed in the middle between the walls, so that the boundary does not change.

In this case, a protrusion-like electrode is formed at the boundary area between the two divided upper and lower areas on the wall electrode side where a gap between the wall electrode and the opposite electrode is wider. Further, in the case of the opposite electrode, a protrusion-like opposite electrode is formed on the side where a distance with the wall electrode is shorter. These may be formed individually or in a composite manner.

In the case of forming the protrusion on the wall electrode, high contrast can be realized by forming the light-shielding black matrix BM at the corresponding position.

In FIG. 9A, the opposite electrode 15 is inclined only by the initial bias angle ø relative to the initial alignment direction of liquid crystal in the directions opposed to each other in the two divided upper and lower pixel areas. In addition, a protrusion structure 22-1 is provided on the left wall electrode 17 at the boundary area between the two divided upper and lower areas.

In FIG. 9B, a middle portion of the opposite electrode 15 is substantially parallel to the stretching direction of the walls, and the tip sections are inclined only by the initial bias angle ø relative to the initial alignment direction of liquid crystal in the directions opposed to each other. In addition, a protrusion structure 22-1 is provided on the left wall electrode 17 at the boundary area between the two divided upper and lower areas.

In FIG. 9C, a protrusion structure 22-2 is further formed at the boundary area of the opposite electrode 15 between the two divided upper and lower areas on the side where a distance with the wall electrode is shorter in FIG. 9B.

In FIG. 9D, the opposite electrode 15 is inclined only by the initial bias angle ø relative to the initial alignment direction of liquid crystal in the directions opposed to each other in the two divided upper and lower pixel areas. In addition, a protrusion structure 22-2 is provided on the opposite electrode 15 at the boundary area between the two divided upper and lower areas.

### Eighth Embodiment

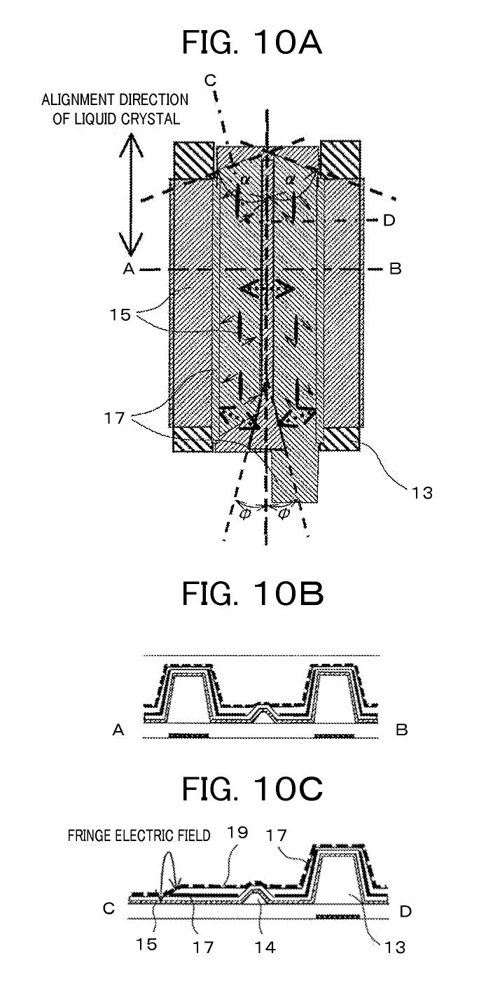

FIG. 10 are diagrams each explaining a structure of a liquid crystal display device according to an eighth embodiment of the present invention. FIG. 10A shows a plan view of one pixel, FIG. 10B shows a cross-sectional view taken along the line A-B, and FIG. 100 shows a cross-sectional view taken along the line C-D. The embodiment is applied to a liquid crystal display device that compensates a viewing angle by dividing the pixel area into a right area and a left area.

As shown in FIG. 10A, a substantially symmetrical bent structure having a bias angle ø (0<ø<20 degrees) relative to the initial alignment direction of liquid crystal is formed at one (lower) terminal portion of the opposite electrode 15 formed between the wall electrodes.

In addition, the bent portion having a bias angle is not formed at the other (upper) terminal portion of the opposite electrode 15, and ends of the pixel electrodes extending in a flat area of the pixel from the wall electrodes 17 are inclined only by the angle α (0<α≦90 degrees) in the rotational direction same as the bias angle ø relative to the initial alignment direction of liquid crystal, so that a substantially symmetrical notch end of the pixel electrode is formed.

Specifically, as shown in the cross-sectional view in the C-D direction of FIG. 100, a fringe electric field is formed between the transparent common electrode extending from the opposite electrode 15 and a notch end of the transparent pixel electrode extending from the wall electrode 17 that is formed above the common electrode through the interlayer insulating film 16 near each of the ends of the pixel electrodes in the flat area of the pixel. In addition, the thickness of the insulating film on the pixel electrode is made thinner, so that the fringe electric field is intensified, the rotation of liquid crystal is controlled, and accordingly reverse rotation domains of liquid crystal are prevented from being generated.

Further, the width of the opposite electrode in the middle of the pixel is made smaller, so that the transmittance can be further improved.

According to the embodiment, two domains in which the rotational directions of liquid crystal are opposed to each other are formed on the right and left sides in the pixel, and the boundary therebetween is fixed and not moved on the opposite electrode disposed in the middle between the walls. Accordingly, a viewing angle can be compensated, and changes of the color tone can be prevented in the all orientations.

### Ninth Embodiment

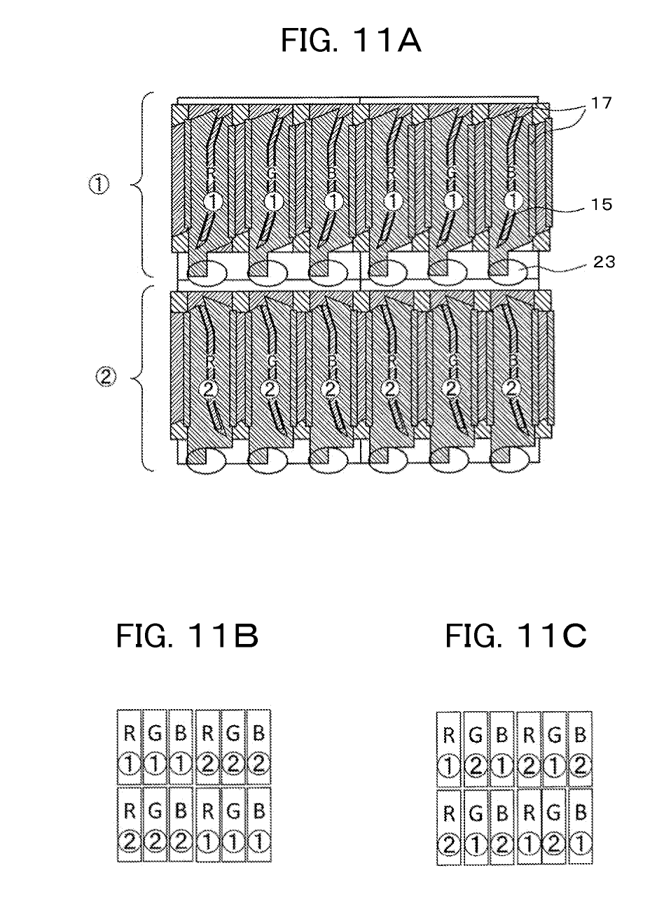

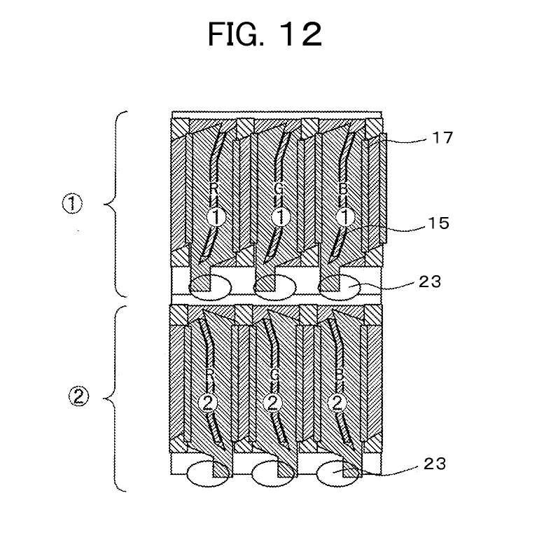

FIGS. 11A to 11C and FIG. 12 are diagrams each explaining a structure of a liquid crystal display device according to a ninth embodiment of the present invention. The embodiment is applied to a liquid crystal display device that compensates a viewing angle in adjacent pixels.

In each drawing, each pixel has the pixel structure of the fourth embodiment. Specifically, a middle portion of each opposite electrode 15 is stretched in the direction substantially parallel to the initial alignment direction of liquid crystal, and terminal portions are inclined only by the bias angle ø (0<ø<20 degrees) relative to the initial alignment direction of liquid crystal. In addition, pixels (1) are pixels in which the inclined bias angle ø of each terminal portion is in the clockwise direction and pixels (2) are pixels in which the inclined bias angle ø of each terminal portion is in the counterclockwise direction.

In FIG. 11A, the clockwise pixels (1) and the counterclockwise pixels (2) are disposed adjacent to each other in the vertical direction. According to the embodiment, a viewing angle can be compensated among the pairs of upper and lower pixels.

In FIG. 11B, sets of RGB pixels are used, and sets of the clockwise pixels (1) and sets of the counterclockwise pixels (2) are disposed adjacent to each other in the vertical and horizontal directions. According to the embodiment, a viewing angle can be compensated among the sets of upper, lower, right, and left pixels.

In FIG. 11C, using each of RGB pixels, the clockwise pixels (1) and the counterclockwise pixels (2) are disposed adjacent to each other in the vertical and horizontal directions. According to the embodiment, a viewing angle can be compensated among the upper, lower, right, and left pixels.

In FIG. 12, thin film transistors (TFTs) are disposed in accordance with the symmetry of the pixel. In FIG. 11A, the TFTs are disposed on the left sides of the clockwise pixels (1) and the counterclockwise pixels (2) relative to the drain wirings (video signal wirings) provided in the stretching direction of the walls. However, in FIG. 12, the TFTs are disposed on the right and left sides in accordance with the clockwise pixels (1) and the counterclockwise pixels (2).

What is claimed is:

1. A liquid crystal display device comprising a pair of parallel wall-like electrodes disposed on the both sides of a pixel,
wherein the initial alignment direction of liquid crystal is a homogeneous alignment direction that is substantially parallel to or orthogonal to the extending direction of a wall surface on which the wall-like electrodes are formed,
the transmittance of light is controlled by driving liquid crystal with an electric field substantially parallel to a substrate plane, and
adjacent two electrodes are formed between the pair of wall-like electrodes so that an electric field inclined by a bias angle (90+ø or −ø) relative to the stretching direction of the wall surface is generated substantially parallel to the substrate plane.

2. A liquid crystal display device comprising:
two parallel wall electrodes that are disposed on the both sides of a pixel;
an opposite electrode that is disposed in the middle between the two parallel wall electrodes; and
a photo-alignment film,
wherein the initial alignment direction of liquid crystal of the photo-alignment film is substantially parallel to or orthogonal to the stretching direction of the two parallel wall electrodes, and the opposite electrode is inclined only by a predetermined bias angle relative to the initial alignment direction of liquid crystal.

3. The liquid crystal display device according to claim 2,
wherein liquid crystal is positive liquid crystal,
the initial alignment direction of liquid crystal is substantially parallel to the stretching direction of the two parallel wall electrodes, and
the opposite electrode is inclined only by a predetermined bias angle ø (ø is 1 to 20 degrees) relative to the initial alignment direction of liquid crystal.

4. The liquid crystal display device according to claim 2,
wherein liquid crystal is negative liquid crystal,
the initial alignment direction of liquid crystal is substantially orthogonal to the stretching direction of the two parallel wall electrodes, and
the opposite electrode is inclined only by a predetermined bias angle (90+ø or −ø) (ø is 1 to 20 degrees) relative to the initial alignment direction of liquid crystal.

5. The liquid crystal display device according to claim 2,
wherein the opposite electrode is linearly formed and inclined only by the predetermined bias angle relative to the initial alignment direction of liquid crystal.

6. The liquid crystal display device according to claim 2,
wherein a middle portion of the opposite electrode is linearly formed and is substantially parallel to or orthogonal to the two parallel wall electrodes, and
at least one tip section of the opposite electrode is inclined only by the predetermined bias angle relative to the initial alignment direction of liquid crystal.

7. The liquid crystal display device according to claim 6,
wherein the length of the middle portion of the opposite electrode is longer than the length of the tip section inclined only by the predetermined bias angle.

8. The liquid crystal display device according to claim 2,
wherein the wall electrodes extend from a surface close to the substrate in the direction of the opposite electrode to form pixel electrodes, and
the opposite electrode extends on the entire surface of the pixel to form a common electrode.

9. The liquid crystal display device according to claim 2,
wherein the opposite electrode extends in the plane direction of the substrate to form a pixel electrode, and
the wall electrodes extend in the direction of the adjacent pixel to form common electrodes.

10. The liquid crystal display device according to claim 2,
wherein the position of the wall electrode located far from the opposite electrode that is inclined only by the predetermined bias angle is relatively the same as the position of the tip section of the opposite electrode or extends outside the pixel.

11. The liquid crystal display device according to claim 2,
wherein the position of the wall electrode located near the opposite electrode that is inclined only by the predetermined bias angle is relatively the same as the position of the tip section of the opposite electrode or does not extend outside the pixel.

12. The liquid crystal display device according to claim 2,
wherein the wall electrodes are terminated in the middle of the wall structures.

13. The liquid crystal display device according to claim 2,
wherein ends of the pixel electrodes extending in a flat area of the pixel from the wall electrodes are inclined only by a predetermined angle α (0<α≦90 degrees) relative to the initial alignment direction of liquid crystal at upper and lower ends of the pixel area.

14. The liquid crystal display device according to claim 2,
wherein the tip section of the wall electrode located far from the tip section of the opposite electrode that is inclined only by the predetermined bias angle forms an L-shaped structure that is bent substantially at a right angle relative to the stretching direction of the walls, and the position of the tip section is relatively the same as the position of the opposite electrode in the stretching direction of the walls or extends outside the pixel farther than the opposite electrode.

15. The liquid crystal display device according to claim 2,
wherein a light-shielding black matrix is formed at an area parallel to scanning wirings without forming the light-shielding black matrix at the wall portions parallel to signal wirings.

16. The liquid crystal display device according to claim 2,
wherein one pixel is divided into two areas,
the opposite electrode or the tip sections of the opposite electrode are inclined only by the predetermined bias angle relative to the initial alignment direction of liquid crystal in the directions opposed to each other in the two divided pixel areas, and
a protrusion structure is provided at the wall electrode or the opposite electrode at a boundary area between the two divided pixel areas.

17. The liquid crystal display device according to claim 2,
wherein pixels in which the predetermined bias angle of the opposite electrode relative to the initial alignment direction is in the clockwise and counterclockwise directions are disposed adjacent to each other in the vertical and horizontal directions.

18. The liquid crystal display device according to claim 16,
wherein respective RGB pixels or sets of RGB pixels are disposed adjacent to each other in the vertical and horizontal directions.

19. The liquid crystal display device according to claim 2,
wherein thin film transistors are disposed on the right and left sides relative to signal wirings in accordance with the symmetry of the pixel.

20. A liquid crystal display device comprising:
two parallel wall electrodes that are disposed on the both sides of a pixel;
an opposite electrode that is disposed in the middle between the two parallel wall electrodes; and
a photo-alignment film,
wherein the initial alignment direction of liquid crystal of the photo-alignment film is substantially parallel to the stretching direction of the two parallel wall electrodes,
a substantially symmetrical bent structure having a predetermined bias angle ø (ø is 1 to 20 degrees) relative to the initial alignment direction of liquid crystal is formed at one terminal portion of the opposite electrode,
the bent structure having the bias angle is not formed at the other terminal portion of the opposite electrode,
ends of pixel electrodes extending in a flat area of the pixel from the wall electrodes are inclined only by a predetermined angle α (0<α≦90 degrees) in the rotational direction same as the bias angle relative to the initial alignment direction of liquid crystal, and
a substantially symmetrical notch end of the pixel electrode is formed.
